(19) United States
(12) Patent Application Publication
(10) Pub. No.: US 2004/0047365 A1
(43) Pub. Date: Mar. 11, 2004

(54) Communications system enabling mobility and special services in an ip network

(76) Inventors: Philip J Williams, Bristol (GB); Jeremy D Foss, Warwickshire (GB)

Correspondence Address: Kirschstein Ottinger, Israel & Schiffmiller, 489 Fifth Avenue, New York, NY, 10017-6105, US

(21) Appl. No.: 10/380,782

(22) PCT Filed: Oct. 8, 2001
(86) PCT No.: PCT/GB01/04450

(30) Foreign Application Priority Data
Oct. 7, 2000 (GB) 0024620.7

(51) Int. Cl. H04L 12/28

(52) U.S. Cl. 370/465

(57) ABSTRACT

A communications protocol for providing a connection-oriented interconnection via an internet protocol communications system (for example, via the Internet) between a first mobile terminal and a node (for example a fixed or mobile terminal or a server), in which the first mobile terminal and the node form part of an internet session; in which the first mobile terminal is initially connected to the node via a first mobile controller (MC) in which the protocol comprises means for providing to the first MC an internet address relating to the node and a record number identifying the internet session. The protocol also provides for maintaining the session as the interconnection between the first mobile terminal and the node is redirected form via the first MC to via a second MC.

The present invention relates to a communications system and a communications protocol therefor, and more particularly to such a system and a protocol in which mobile terminals can be accommodated in a connection-oriented mode in an internet protocol communications system.

1.a.

The “connection-oriented mode” is described in related published British patent application “A Communications Network”, publication number GB 2313271, assigned to Marconi Communications Limited which is incorporated herein by reference. To assist the reader, a brief outline of the connection-oriented mode is provided next.

2.a.

The connection-oriented mode enables Internet sessions to be conducted in a connection-oriented manner along with conventional connectionless sessions. This will require Internet sessions to use virtual message-paths made up of a series of virtual channels, one for every link of the path. Once a virtual message-path has been established at the start of a session, messages may be passed in either direction using only a number which identifies the virtual message-path on each link of the path (by means of a virtual channel number (VCN)) so avoiding the need to add an address to each message.

2.b.

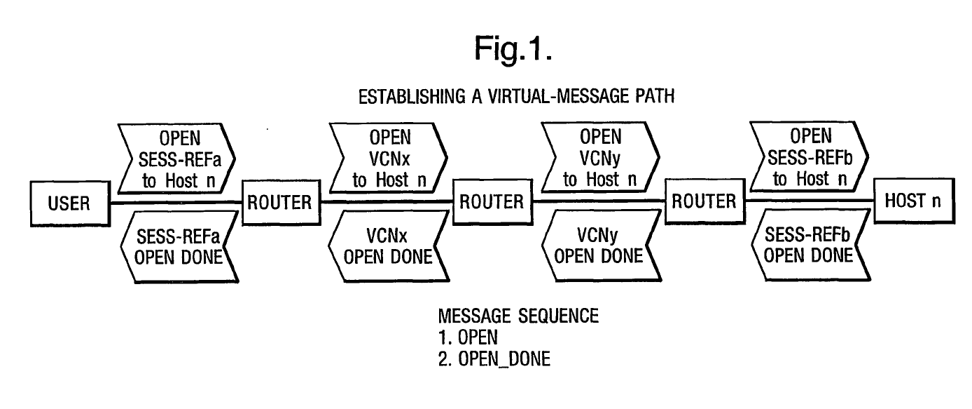

By way of introduction, the connection-oriented Internet session known from the related patent application will be described with reference to FIG. 1.

The connection-oriented mode works by the establishment of a virtual message-path between two Internet terminals and enables those terminals to engage in dialogue as though they were directly interconnected. (i.e. the network is told that all messages from terminal A, activity x must be passed to terminal B, activity y, and vice-versa). The conventional Internet is one example of an internet protocol communications system but is not “connection-oriented” (i.e. it is not told of a relationship between terminal A and terminal B) and requires that each message-packet from either terminal is individually addressed to the other terminal.

2.b.

To establish a “connection-oriented” session, a user opens a virtual channel to its local Internet router (Internet access point) and sends an OPEN message containing the internet address of the distant, destination terminal and identifying the protocols available for the transport layer activity which will use the virtual message path. A suitable format for each message type is given at the end of the description. In the following, the router providing the Internet access point to the user initiating a session is referred to as the “source router”. Similarly, the router providing the Internet access point to the destination terminal is referred to in the following as the “destination router”.

An internet session is taken to include all activity on the virtual message path set up as a result of the initial OPEN message together with all activity on any further virtual message paths added to the session or to which an existing virtual message path forming part of the session is transferred.

In the conventional Internet a user sends the internet name of the desired destination terminal via its local router to the Internet domain name server (DNS) which returns the appropriate address to the user. The user is then able to use the destination internet address to access the desired destination. The conventional internet address comprises two parts: the network identity (NetID)) identifies the network in which the destination terminal is located whilst the user identity (UserID) uniquely identifies the desired destination terminal within the identified network.

When the destination terminal is not a “special-service” (see below) the source router identifies the route towards the destination, allocates a virtual channel number (e.g. VCNx in FIG. 1) on the link to the next router and forwards the OPEN message. The process is repeated until a virtual message path consisting of the successive virtual channels (VC) is established from the source to the distant destination terminal. The distant destination terminal returns an OPEN-DONE message stating the chosen protocol, link capacity and switching priority required. The transport layer activity now commences.

2.c.

Each router records the path in its switching table

e.g. Link A channel M switches to Link B channel N

Link B channel N switches to Link A channel M.

Messages arriving at the router from Link A labeled “M” will be re-labeled “N” and put into Link B output buffer—and vice-versa. The switching table at the source router contains the identification of the link to the user terminal and an arbitrary reference number allocated by the user for uniquely identifying the present session. The switching table at the destination router contains the identification of the link to the destination terminal and an arbitrary reference number allocated by the destination router for uniquely identifying the present session to the destination terminal.

Control messages (OPEN,CLOSE etc.) use a control message channel, the control message header indicating the channel number to which the message applies; the header will be modified as control messages are passed from link to link.

3.a.

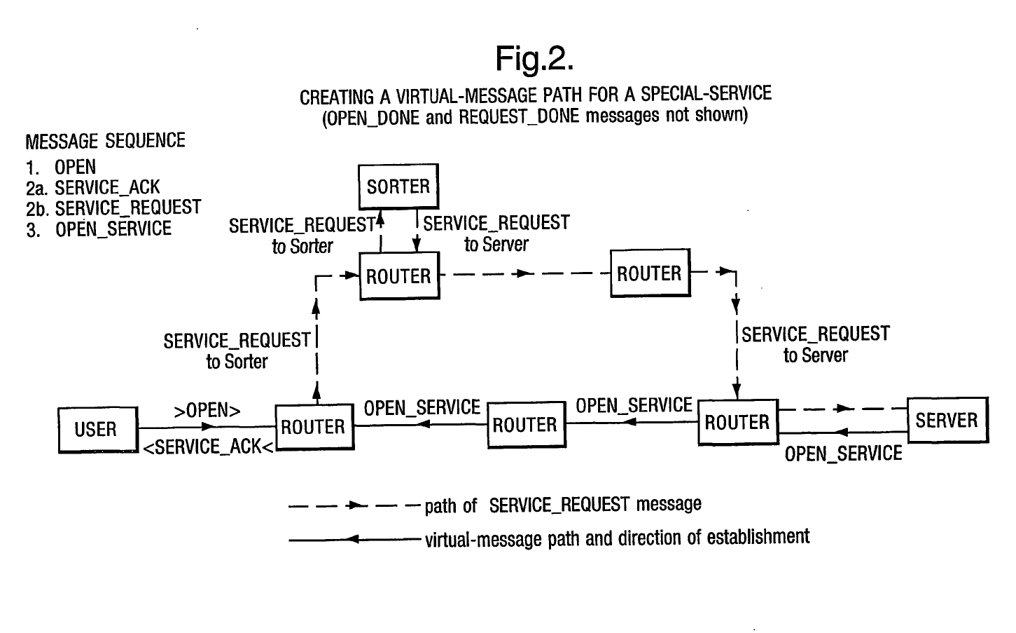

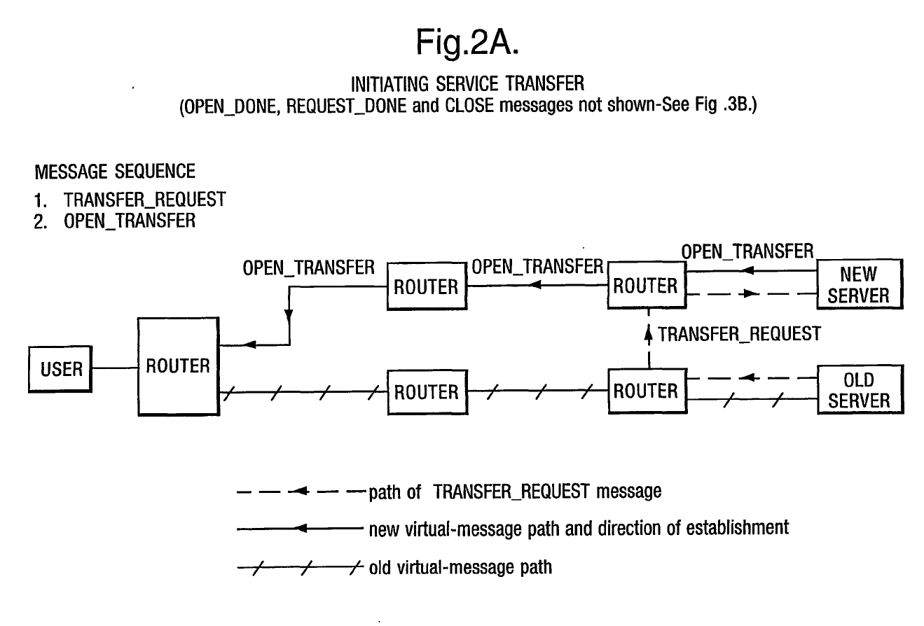

A special-service session will now be described with reference to FIG. 2. A special-service session is one that starts with a user requesting connection to a service provided by a server (i.e. on a “destination” terminal)—but where the service is actually delivered and controlled by the server (i.e. the “destination”) establishing a connection to the user (i.e. the “source”) by means of an OPEN-SERVICE message from the destination end.

3b., 3.c.

In order for a user to access a special service via the connection-oriented mode, the user obtains the internet address of the destination as before, however the Net ID no longer identifies a specific network but merely identifies that a special service is required. This is transparent to the user who uses the Internet address provided by the DNS in the normal manner.

3.d.

The source router is set up to recognise that the user's OPEN message specifies a destination address that is a special-service, and to react by returning a SERVICE_ACK message to the user and sending a SERVICE_REQUEST message to a sorter (see below). The source router also recognises that the charge-record, if any, will be prepared at the distant destination end.

The SERVICE_ACK message tells the user that the initiative to open and close the transport layer activity will be at the distant, destination end, enabling the server to close the activity before transferring the user to another server, if required.

The SERVICE_REQUEST message repeats the destination address and available protocols from the OPEN message. It also contains the user's Internet-name and the source router's own Internet address and its session-record number (see below).

With the connection-oriented service, a router needs to keep a record of each active session handled by it. When the virtual message path is closed, the relevant session record is updated. The session record only relates to that router's part of the session and enables the router to clear the relevant entries in its switching table, release the virtual channel numbers associated with that session and to release the reserved capacity on the links. The session-record may also be used for user accounting, inter-provider accounting, traffic recording and a variety of internal administrative purposes.

As described in the related Application the sorter is a message re-addressing service attached to any convenient router and having an internet address similar to any other terminal on that router. By updating the sorters, services can be introduced, relocated or terminated. The sorter uses the “distant-host-address” destination address field in the SERVICE_REQUEST message to identify the true Internet address of the desired server. The address of the sorter in the

SERVICE_REQUEST message is amended to the true internet address of the desired destination. Hence the sorter re-addresses the SERVICE_REQUEST message to the required server.

In forwarding the message via the sorter to the server a message-path is created for the return of a REQUEST_DONE or FAILURE message from the server to the originating router.

3.e., 3.f.

Being aware of the user's identity enables the server to offer only the services considered appropriate for that user and so controls unauthorised access to services.

The server uses an OPEN_SERVICE message to open a virtual message path to the source router, i.e. to the router address given in the SERVICE_REQUEST message. The OPEN_SERVICE message contains the session-record number copied from the SERVICE_REQUEST message received from the sorter and the user's internet name for verification by the source router. The message also indicates the chosen protocol and the capacity and message switching priority required for the session but the information is not used until transferred to OPEN_DONE messages. If the Internet name check fails, the BSC will return a FAILURE message instead of an OPEN_DONE message.

3.g.

The OPEN_SERVICE message is treated as a normal OPEN message by all routers except the source router. When the OPEN_SERVICE message is received from the distant destination end, the source router uses the session record number to identify the original virtual channel. established by the user to the source router by means of the original OPEN message. The source router extends the virtual message-path from the destination to the user via the original virtual channel. This action is referred to as “picking-up” the virtual message path. The same action is required when a virtual message-path is changed in response to an OPEN TRANSFER or OPEN_MOB_TRANSFER message (see below).

3.h., 3.i.

A server may pass the relevant contents of a SERVICE_REQUEST message to another server in a TRANSFER_REQUEST or ADD_REQUEST message enabling the responsibility for service delivery to be transferred to another server or supplementing service delivery by introducing an additional server (see FIG. 2A). The user is not involved in the transfer process, does not acquire the address of the additional server and so cannot bypass the first server on subsequent occasions. Also, service is delivered by the new or additional server directly to the user and details of the service delivered are not revealed to any other server involved in service delivery. For example, the first special-service server might be an insurance broker and the additional servers might be access points of relevant insurance companies. Alternatively, the first server might be the front-office of a multi-national business corporation leading to additional servers located in all the component parts of the business, and leading in turn to their sub-contractors and sub-sub contractors.

3.j.

A server transfers a user to another server by closing the transport layer activity and sending a TRANSFER_REQUEST message to the other server. The TRANSFER_REQUEST message contains the same information as the original SERVICE_REQUEST message, but indicates that the existing virtual message-path must be diverted. The message will usually be addressed directly to the other server, but may be addressed via a Sorter as before, in which case the “Distant_host_address” field must be updated, as described in the related Application.

The TRANSFER_REQUEST message may include information obtained during the earlier part of the session and may indicate which party is expected to pay for the transferred service. All such information is of no consequence to the Internet. The TRANSFER_REQUEST message will be forwarded to the new server and a message-path created for the return of a REQUEST_DONE or FAILURE message from the new server to the server initiating the transfer.

3.k.

The new server uses an OPEN_TRANSFER message to create a virtual message-path to the source router. The message is similar to an OPEN_SERVICE message: it includes the source router's session-record number and the user's internet name from the TRANSFER_REQUEST message. It also indicates the protocol chosen by the new server for use over the new part of the virtual message path including the new capacity and priority requirements, but this information is not used until transferred to OPEN_DONE messages.

3.l.

The OPEN_TRANSFER message is treated as an ordinary OPEN message by all Routers except the source Router which uses the session-record number to identify the session and pick-up the message-path to the user. It also returns OPEN_DONE messages to the new server and to the user containing the protocol, capacity and priority requirements indicated in the OPEN_TRANSFER message. The message title informs the source router that its session-record and switching table contain entries relating to the previous message path. These entries must be updated and a CLOSE_REQUEST message must be sent to the old server on the previous message-path.

3.m.

Upon receiving the OPEN_DONE message the new server will return REQUEST_DONE to the old server on the message path created by the TRANSFER_REQUEST. Upon receiving the REQUEST_DONE message the old server will close the TRANSFER_REQUEST message path and upon receiving the CLOSE_REQUEST message from the source router the old server will close the previous message path.

3.n., 3.o.

A server may add another server by sending an ADD_REQUEST message to a new server containing the same information that would be contained in a TRANSFER_REQUEST message. The new server will establish a new virtual message-path to the user with an OPEN_ADD message containing the same information that would be contained in an OPEN_TRANSFER message. The source router will return an OPEN_DONE message to the new server which will send REQUEST_DONE to the server that initiated the addition. As described in the related application (see Part 1 “Creating a Virtual Message Path”, in the section headed “The host/router link”) sub-session numbers may be allocated to cope with the situation where a number of servers are in communication as part of the same session with a user over the same virtual channel. The source router will hence allocate a sub-session number for the new virtual message path and include it in the header of an ADD_DONE message to the user. The ADD DONE message also contains similar information to that contained in the OPEN_DONE message. The sub-session number is to identify the traffic flow over the new virtual message path to allow the user to distinguish between traffic sent or received via different virtual message paths.

3.p.

Upon receiving the ADD_DONE message, the user terminal will open a new activity as required to handle traffic to/from the new server. However, the connection orientated mode of the prior art does support the needs of mobile terminals.

The present invention provides a communications protocol for providing a connection-oriented interconnection via an internet protocol communications system between a first mobile terminal and a node, in which the first mobile terminal and the node form part of an internet session; in which the first mobile terminal is initially connected to the node via a first mobile controller (MC) in which the protocol comprises means for providing to the first MC an internet address relating to the node and a record number identifying the internet session.

According to a preferred embodiment, the present invention includes the step of maintaining the session as the interconnection between the first mobile terminal and the node is redirected from via the first MC to via a second MC.

Preferred embodiments of the present invention will now be described by way of example with reference to the drawings in which:

FIGS. 1 and 2 illustrate operation of a protocol according to the prior art;

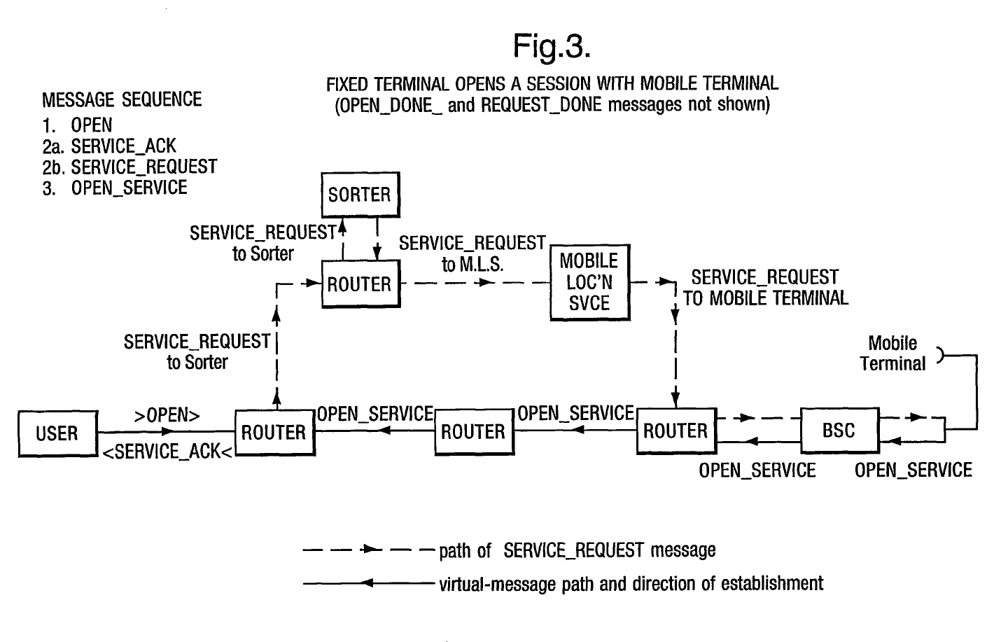

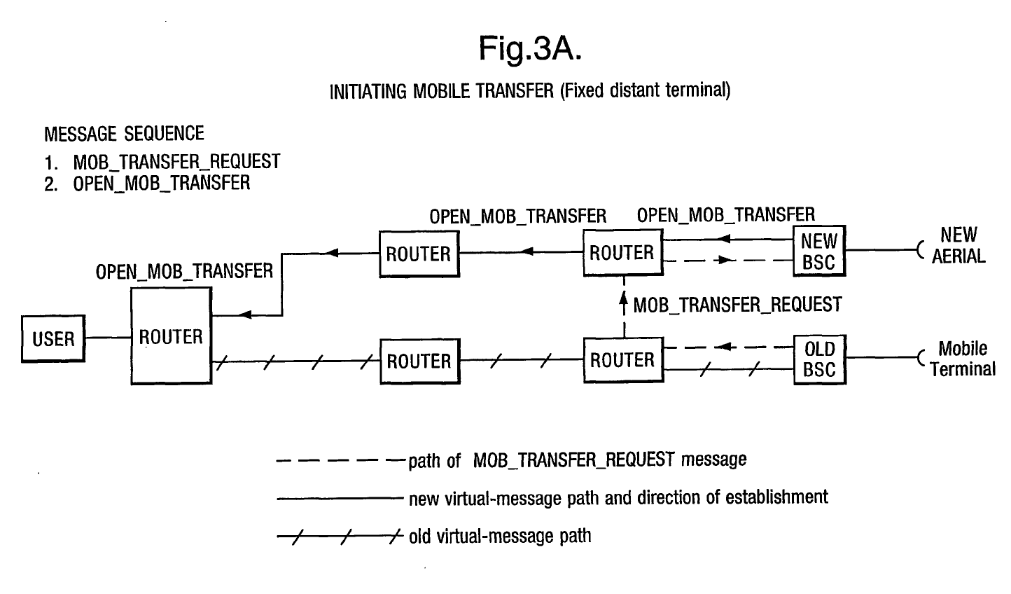

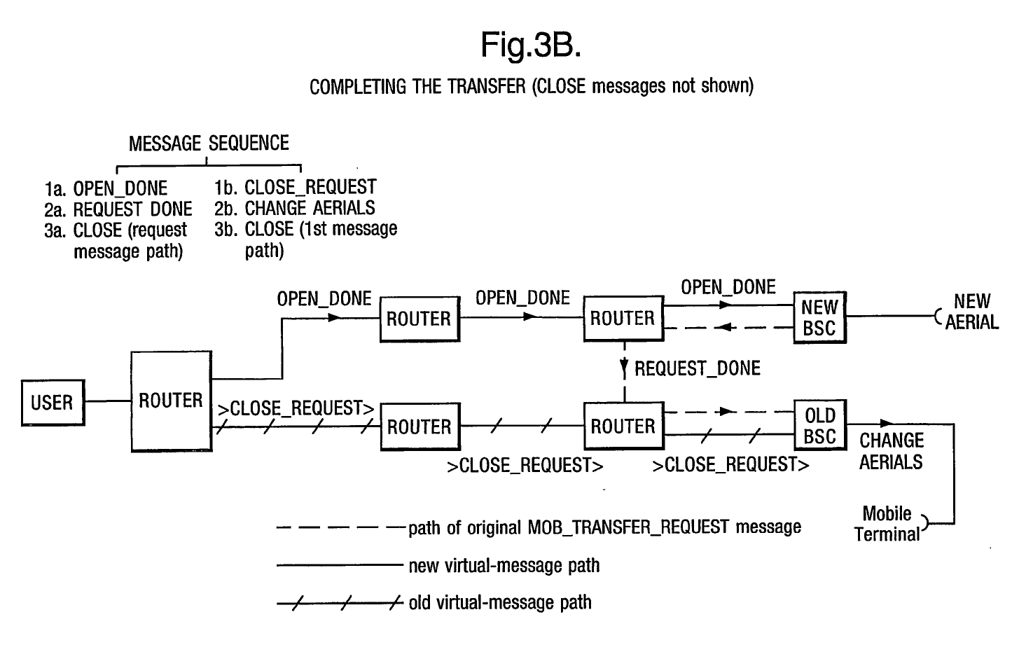

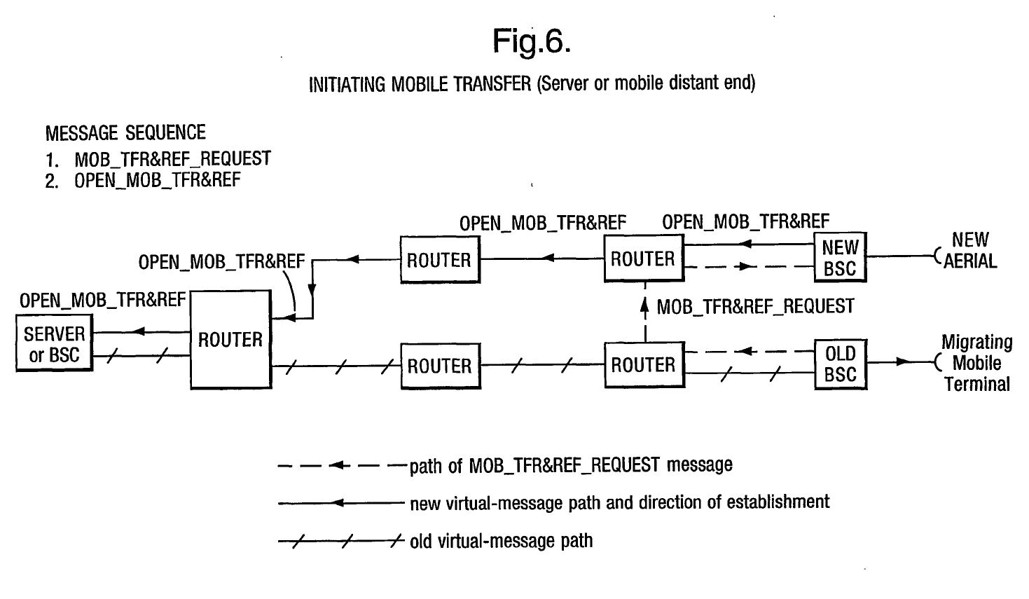

FIGS. 3 to 6 illustrate operation of a protocol according to the present invention.

### 4. SESSIONS TERMINATED BY MOBILE TERMINALS

Sessions terminated by mobile terminals according to the present invention will now be described with reference to FIG. 3.

4.a.

A mobile network consists of a network of aerial towers so arranged that a mobile terminal is always within range of at least one tower. Indeed, other than at the very extremities of the network a terminal is constantly within range of several towers.

4.b.

All on-line (switched-on) mobile terminals, whether in use or dormant, are constantly monitoring and being monitored by all in-range towers. A inter-active process enables the towers and terminals to identify the tower currently most appropriate for each terminal. The tower so identified is considered to be the terminal's current location. The situation is constantly updated as terminals move from place to place.

4.c.

The current location and identity of each on-line mobile terminal is reported to a network location register (e.g. located at the mobile network HQ) which must be consulted when traffic is to be directed to a mobile terminal.

4.c.

Several adjacent aerial towers are controlled by a single Base Station Controller (BSC) which is the access point for those towers to and from the greater network and enables access to the telephone network and Internet.

4.e.

The network must accommodate an orderly “handover” when a mobile terminal moves from one aerial tower to another in mid-session. The move may include moving from one BSC area to another.

4.f.

According to the present invention each BSC has access to an internet router and is allocated an internet address but the mobile network is not an integral part of the Internet and may have access to other means of communication (e.g. the public switched telephone network).

5.a.

Referring to FIG. 3, according to a preferred embodiment of the present invention, the network identity (NetID) of a mobile terminal will be a special-service NetID. When a user requests access to a mobile terminal, the user's source router will send a SERVICE_ACK message to the user and a SERVICE_REQUEST message to a sorter. The router will also identify that the charge-record (if any) will be produced at the distant end.

The sorter re-addresses the SERVICE_REQUEST message to the appropriate Mobile Location Service (MLS) which holds the current location of the mobile terminal and the identity of each mobile terminal's currently active BSC. The MLS re-addresses the SERVICE_REQUEST message to the mobile terminal's currently active BSC, which sends it to the mobile terminal.

5.b.

The SERVICE_ACK message informs the user that the distant destination end is a special-service or a mobile terminal. The initiative to open and close the transport layer activity will belong to the distant destination end.

5.c.

Upon receiving the SERVICE_REQUEST message the mobile terminal uses the source router address and session-record number obtained from the SERVICE_REQUEST message in an OPEN_SERVICE message to open a virtual message-path through the Internet to the source router and to pick-up the virtual message-path to the user. The BSC stores the source router address and session-record number from the OPEN_SERVICE message in its own session-record for use if the mobile terminal migrates to another BSC during the session.

5.d.

If required, a charge record for the session will be produced by the BSC in a similar way to those currently produced by BSC's for telephone calls originated in the mobile network. The distant (source) end will normally be charged for sessions opened with an OPEN_SERVICE message as identified by the User's Internet name in the message, but if the mobile terminal behaves as a server it may wish to absorb or supplement the charge. A charge record may also be produced by the BSC's local router in order to charge the Mobile Network Provider for use of the Internet. All such details are administrative in nature and of no consequence to the present invention.

5.e.

The OPEN_SERVICE message also indicates the chosen protocol and the capacity required for the virtual message path, but the information is not used until transferred to OPEN_DONE messages returned to the mobile terminal and to the user by the source router. OPEN_DONE messages indicate the chosen protocol to the user and inform the end setting up the virtual message path (in this case the mobile terminal) that the message path is complete. They also indicate to all routers along the message path the network capacity to be reserved and the message switching priority required for the virtual message path.

6.a. Mobile Terminal Moves to new BSC Area.

Mobile transfer and “seamless” hand-over will now be described with reference to FIGS. 3A and 3B. When a mobile terminal migrates from one BSC area to another in mid-session, the first BSC sends via the Internet a MOB_TRANSFER_REQUEST message to the new BSC (see FIG. 3A). For this purpose each BSC will need to know the Internet addresses of its adjacent BSCs. The message identifies the mobile terminal, and repeats the source router address and session-record number taken from the OPEN_SERVICE message.

6.b.

The new BSC prepares to receive messages from the mobile terminal via the new aerial tower but provides a buffer to store any messages destined for the mobile terminal that may be received from the user prior to completion of the handover. It then uses an OPEN_MOB_TRANSFER message with the address and record number from the MOB_TRANSFER_REQUEST message, to open a virtual message-path through the Internet and pick-up the virtual message-path to the user. The word MOB in the title of the OPEN_MOB_TRANSFER message indicates that a “seamless” transfer is required. i.e. changing the virtual message-path being used by the session without disturbing the session. Thus, the new BSC arranges that, when messages are received from the mobile terminal via the new aerial tower they will be sent to the user; and that messages received from the user will be put into a buffer at the new BSC (to be forwarded to the mobile when it has changed to the new aerial tower).

6.c.

The OPEN_MOB_TRANSFER message is treated as an ordinary OPEN message by all routers except the source router which uses the session-record number to identify the session and amends its switching tables to use the new virtual message-path. However, the source router continues to pass to the user any messages received from the mobile on the old virtual message-path.

Thus, on receipt of the OPEN_MOB_TRANSFER message the source router arranges that messages received from the mobile on either the old or the new virtual message-path will be passed to the user; messages from the user to the mobile will be sent on the new channel only.

6.d.

Completion of the handover will now be described with reference to FIG. 3B. The next step following receipt of the OPEN_MOB_TRANSFER message is for the source router to return an OPEN_DONE message via the new virtual message-path to the new BSC and send a CLOSE_REQUEST message via the old virtual message-path to the old BSC. The OPEN_DONE message repeats the capacity and priority requirements from the old virtual message-path (the “chosen protocol” field is not used).

6.e. Upon receiving the OPEN_DONE message, the new BSC sends a REQUEST_DONE message to the old BSC which closes the virtual message-path created by the MOB_TRANSFER_REQUEST message.

6.f

The CLOSE_REQUEST message indicates that the source router has begun to use the new message path. By the time it is received at the old BSC, any user-to-mobile messages in the pipeline via the old message path will have cleared. Upon receiving the message, the old BSC instructs the mobile to change to the new aerial tower (i.e. to start communicating via the new BSC). When it detects that the mobile has changed, the old BSC sends a CLOSE message to the source router on the old virtual message-path. The CLOSE message indicates that the old BSC has ceased to use the old message path and by the time it reaches the source router, any mobile-to-user messages in the pipeline via the old virtual message-path will have cleared. When received, the source router amends its switching table to cease passing messages received from the old virtual message-path to the user. When the new BSC detects that the mobile has transferred to the new aerial tower it sends the contents of its storage buffer to the mobile terminal and, when empty, amends its switching table to send future messages directly to the mobile terminal.

### SESSIONS ORIGINATED BY MOBILE TERMINALS

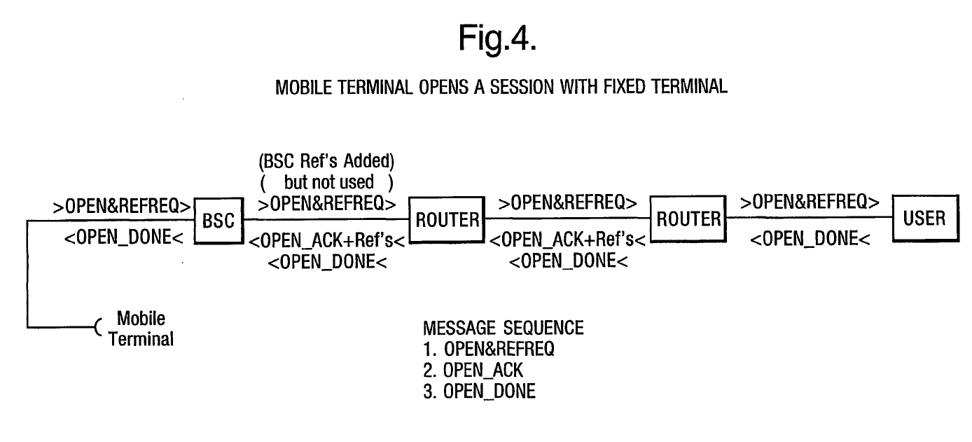

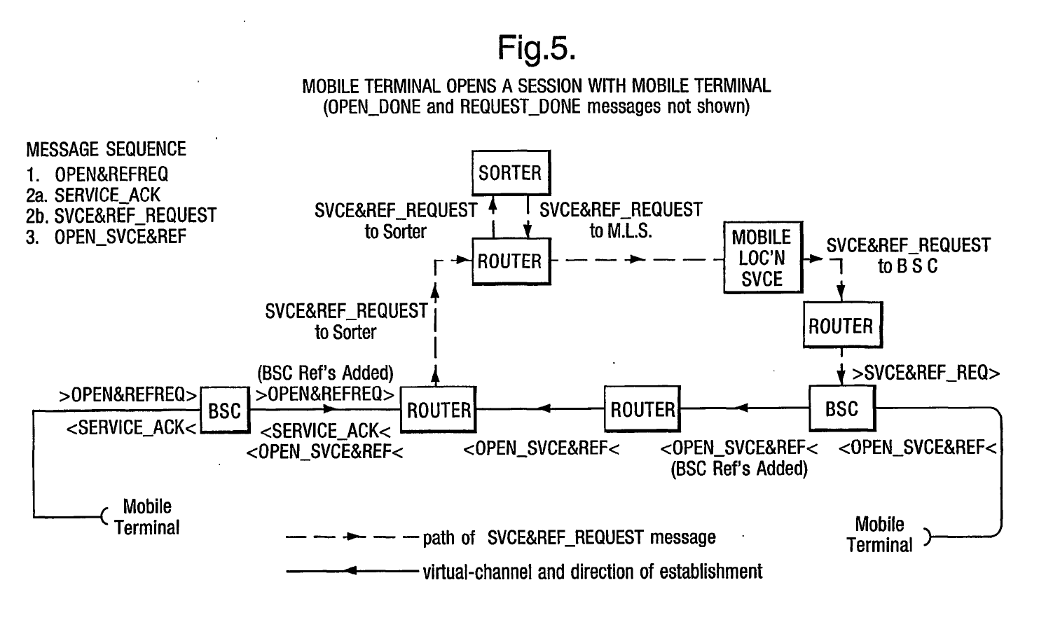

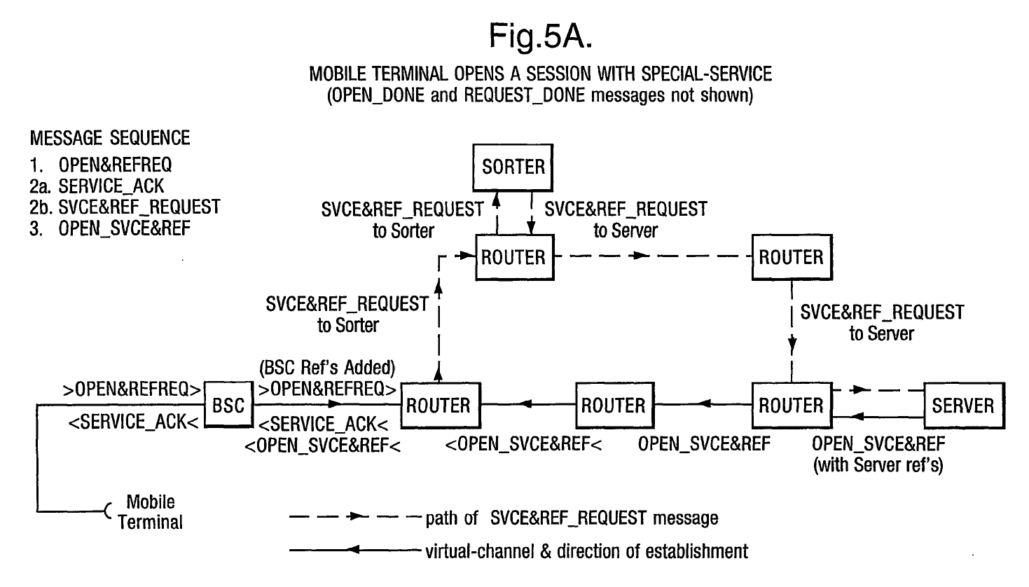

The previous section showed how a mobile terminal can be accommodated at the destination end of an internet session. Further preferred embodiments of the present invention will now be described with reference to FIGS. 4, 5 and 5A according to which an Internet session can be originated by a mobile terminal. According to this embodiment, a similar procedure may be used to that described above with reference to a session originated by a fixed terminal.

7.a. Mobile Terminal to Fixed Terminal

Operation of a mobile terminal in originating an ordinary session (i.e. not to a special-service or another mobile terminal) will now be described with reference to FIG. 4.

A mobile terminal originates a session by sending an OPEN&REFREQ message to its BSC (the “source” BSC) containing the address of the destination end and listing the available protocols. Inclusion of the term “REFREQ” in the message title indicates that the destination router should return its address and session record number to the originating BSC.

7.b.

Before forwarding the OPEN&REFREQ message to the source router (i.e. the source BSCs Internet access point) the source BSC adds to the message its own internet address, its session record number and the internet name of the mobile terminal (mobile terminals cannot provide their own name for security reasons). This information will be used by the BSC's local router if the distant end address is a special-service or another mobile terminal.

7.c.

If the distant destination address is not a special-service or mobile terminal, the OPEN&REFREQ message is treated as an ordinary OPEN message by all routers except the destination router, i.e. the destination terminal's Internet access point. The destination router returns an OPEN_ACK message to the source BSC containing its internet address and session record number before completing the virtual message-path to the addressed destination terminal which returns the OPEN_DONE message.

7.d.

On receipt of the OPEN_ACK message, the source BSC stores the destination router address and session record number. The OPEN-ACK message also indicates that there may be a delay before the OPEN_DONE message can be sent. e.g. when the addressed destination terminal requires use of a wake-up procedure.

A BSC will produce charge records for all sessions where a mobile terminal connected via the BSC acts as the source unless a SERVICE_ACK message is passed via the BSC to the mobile terminal indicating that the distant end will produce the charge-record. The BSC will send charge invoices to the mobile network HQ which will charge the mobile terminal.

### Source mobile terminal migrates to new BSC—(Fixed distant end)

If in moving from one aerial tower to another during the session the source mobile terminal migrates to a new BSC area, the old BSC sends a MOB_TRANSFER_REQUEST message via the internet to the new BSC. The message identifies the migrating mobile terminal and provides the internet address and session-record number of the distant destination router from the OPEN_ACK message. A “seamless” handover follows, as described above with reference to FIGS. 3A and 3B bearing in mind that the mobile terminal is now at the source end and the fixed terminal at the destination end.

9.a. Mobile to Mobile or Mobile to Special-Service Session

A further preferred embodiment of the present invention will now be described with reference to FIGS. 5 and 5A according to which an Internet session can be set up between mobile terminals or from a mobile terminal to a special-service terminal.

9.b.

With reference to FIGS. 5 and 5A, when the source is a mobile terminal and the destination address in the OPEN&REFREQ message identifies a special-service or a mobile terminal, the source router returns a SERVICE_ACK message to the source mobile terminal via the BSC.

The source BSC will have been expecting to receive references in an OPEN_ACK message. The receipt of a SERVICE_ACK message will inform the source BSC that the destination end is a server or BSC that will require new source-end references if the source mobile terminal migrates. The references requested from the destination end will be provided in the OPEN_SVCE&REF message as described below. The message also identifies that the charge record will be prepared at the distant end.

9.c.

The source router also sends a SVCE&REF_REQUEST message to a sorter to invoke service delivery and indicate that the source end is a mobile terminal and that its BSC requires references (i.e. the address and session-record number of the server or terminating BSC). The sorter re-addresses the message directly to the required server—or via the Mobile Location Service and currently active BSC to the required mobile terminal. The internet name, internet address and session record number in the SVCE&REF_REQUEST message will be that provided by the source BSC in the original OPEN&REFREQ message.

9.d.

The destination special-services server or mobile terminal will use an OPEN_SVCE&REF message containing the user's internet name and the source BSC address and session-record number provided in the SVCE&REF_REQUEST message to open a virtual message-path via the Internet to the source BSC which will verify the internet name and use the session record number to pick-up the virtual message-path to the originating mobile terminal. The BSC will close the channel used by the BSC to forward the original OPEN&REF_REQUEST message to its local router.

9.e.

A server will include its own address and session-record number in an OPEN_SVCE&REF message. A destination BSC will add its address and session-record number to the message (generated by the mobile terminal) and will copy the source BSC address and record number from the message into its session-record for use if the destination mobile terminal migrates to another BSC. The source BSC will store the destination references provided in the message for use if the source mobile terminal migrates to another BSC.

9.f

Hence both ends have references (distant-end address and session-record number) enabling them to transfer or handover the session as and when required.

10.a. Service Transfer—with mobile terminal at distant end

If a server needs to transfer a user to another server, where the user is a mobile terminal, the server will initiate service transfer by sending a TFR&REF_REQUEST message to a new server containing the same information as a TRANSFER_REQUEST message but the inclusion of the term “&REF” indicating that the distant end will require the new server's address and session-record number. The new server will use an OPEN _TFR&REF message to create a message-path to the source BSC and pick-up the message-path to the mobile terminal. The message contains the same information as an OPEN _TRANSFER message but includes the new server's address and session-record number. The BSC will return OPEN _DONE to the new server and will send a CLOSE_REQUEST message on the old message path as previously described. It will also replace the old server's references obtained from the OPEN_SVCE&REF message with the new server's references provided in the OPEN _TFR&REF message.

11.a. Mobile Terminal Migrates to Another BSC Area—Server or Mobile Terminal at Distant end.

MOB _TFR&REF_REQUEST messages will be used by BSCs to initiate handover to another BSC when the distant end is a server or another mobile terminal. The message contains the same information as a MOB _TRANSFER_REQUEST message but the inclusion of the term “&REF” indicates that the distant end will require the new BSC's address and session-record number. MOB _TRF&REF_REQUEST messages will also indicate which end produces the charge-record (if any) because the new BSC will not know whether it is at the source or destination end of the session.

11.b.

The new BSC will use an OPEN_MOB_TFR&REF message containing the same information as an OPEN_MOB _TRANSFER message to create a virtual message path to the distant server or BSC and pick-up the session in the seamless manner previously described. The OPEN_MOB _TFR&REF message will include the new BSC's address and session-record number. At the distant end, the server or BSC will replace its previously stored references with those contained in the message.

11.c.

OPEN_MOB TFR&REF messages will indicate which end produces the charge record (if any) in order that source, destination and Gateway routers can produce the necessary charge records. Here a Gateway router is a router that has links to another provider's network and may be required to produce charge records for inter-provider accounting.

12.

The original SVCE&REF_REQUEST message (FIGS. 5 & 5A) informed the destination server or mobile terminal that the source requires references and the use of OPEN_SVCE&REF by the destination mobile terminal conveyed the requirement to the destination BSC. The receipt of an OPEN_SVCE&REF message during the initial set-up informs a source BSC that the destination end requires references. Thereafter the need to provide references is perpetuated by the use of “&REF” in REQUEST message titles.

13.a.,13.b.

According to a further embodiment of the present invention the message exchange between the BSC and the MLS includes the internet name of any mobile terminal that has Internet access. This requires that the MLS is aware of the Internet names of such mobile terminals. The message exchange reporting to the MLS could advantageously take place over the Internet as an alternative to using the overlaying mobile network.

The present invention has been described by way of example with reference to the Internet however, the scope of the invention is not limited to application to the Internet but is applicable to all internet protocol communications systems.

### CONTROL MESSAGES

This section lists the format of the control messages employed in the Enhanced Internet including those required for communications involving mobile terminals. Each of the following messages is preceded, in use, by a Link Header Message identifying the virtual channel number (VCN) to which the message relates. e.g.

Start

VCN 0000 (control message channel)

Total message length

Allocated VCN

Control message (as follows)

Stop

Suitable formats for the control messages referred to above are as follows:

| | |
|---|---|
| OPEN message | |
| IP version | (1) Derived from protocol indicator |
| Message length | specified by User. |
| Function - OPEN | |
| Distant_host_address | (2) Lists the protocols available for |
| Port(1) | service delivery. The number of |
| Available protocols(2) | protocols may be deduced from the |
| Checksum | length field or from a “more” flag |
| OPEN&REFREQ message | |

(used by mobiles to request references from terminating end)

| | |
|---|---|
| IP version | |
| Message length | (1) The originating BSC adds its address, |
| Function - OPEN&REFREQ | record no. and the User's Internet name |
| Distant_host_address | to all OPEN&REFREQ messages for use |
| Port | in a SVCE&REF_REQUEST message if |
| Available protocols | the distant host is a special-service or |
| Orig. BSC's address(1) | another mobile terminal. |
| BSC's session record(1) | |
| User's Internet name(1) | |
| Checksum | |

OPEN_ACK message.(before delayed OPEN_DONE

| | |
|---|---|
| IP version | |
| Message length | (1) The basic ACK message contains no |
| Function - OPEN_ACK | parameters. When used in response to an |
| Dest.router address(1) | OPEN&REFREQ message it holds the |
| Session_record no.(1) | destination router's address and session |
| Checksum | record number. |

OPEN_DONE message

IP version

Message length

Function—OPEN_DONE

Chosen protocol

Forward capacity & priority

Backward capacity & priority

Cheksum

CLOSE_REQUEST message

IP version

Message length

Function—CLOSE_REQUEST (No parameters)

Checksum

CLOSE message

IP version

Message length

Function—CLOSE (No parameters)

Checksum

CLOSE_ACK message. (per link—not end-to-end)

IP version

Message length

Function—CLOSE_ACK (No parameters)

Checksum

SERVICE_ACK message. (generated by router)

| | |
|---|---|
| IP version | No parameters. Informs the User that the |
| Message length | distant destination end is a “special-service” |
| Function - SERVICE_ACK | and that the transport-layer activity will be |
| Checksum | controlled by the distant destination end. |

SERVICE_REQUEST message (generated by router)

| | |
|---|---|
| IP version | |
| Message length | (1) the message is first addressed |
| Function - SERVICE_REQUEST | to a SORTER which re-addresses |
| Sorter/server address(1) | it to the service indicated by the |
| Distant_host_address(2) | Distant_host_address (via Mob. Loc. |
| Source router address(3) | Svce. and current BSC if host is a |
| Session record no.(3) | mobile terminal.) |
| User's Internet name(3) | (2) taken from the OPEN message |
| Available protocols(2) | (3) provided by source router |
| Checksum | |

SVCE&REF_REQUEST message (generated by router)

| | |
|---|---|
| IP version | |
| Message length | (1) the message is first addressed |
| Function - SERVICE_REQUEST | to a SORTER which re-addresses |
| Sorter/server address(1) | it to the service indicated by the |
| Distant_host_address(2) | Distant_host_address (via Mob. Loc. |
| Source router address(3) | Svce. and current BSC if host is a |
| Session record no.(3) | mobile terminal.) |
| User's Internet name(3) | (2) taken from OPEN&REFREQ message |
| Available protocols(2) | |
| Checksum | |

REQUEST_DONE message

| | |
|---|---|
| IP version | |
| Message length | |
| Function - REQUEST_DONE | (No parameters) |
| Checksum | |

OPEN_SERVICE message (generated by server or destination mobile)

| | |
|---|---|
| IP version | |
| Message length | (1) From SERVICE_REQUEST |
| Function - OPEN_SERVICE | message |
| Source router address(1) | |
| Session record no.(1) | |
| User's Internet name(1) | |
| Chosen protocol(2) | (2) Not used until transferred |
| Forward capacity & priority(2) | to OPEN_DONE message. (May |
| Backward capacity & priority(2) | be overridden by OPEN_OLD) |
| Checksum | |

OPEN_SVCE&REF message (generated by server or destination mobile)

| | |
|---|---|
| IP version | |
| Message length | (1) From SVCE&REFREQUEST |
| Function - OPEN_SVCE&REF | message |
| Source BSC address(1) | |
| Session record no.(1) | (2) Not used until transferred to |
| User's Internet name(1) | OPEN_DONE message. (May |
| Chosen protocol(2) | be overridden by OPEN_OLD) |
| Forward capacity & priority(2) | |
| Backward capacity & priority(2) | (3) BSCs add their address and |
| Dest. BSC/server address(3) | and session -record no. to all |
| Dest. BSC/server record no.(3) | OPEN_SVCE&REF messages |
| Checksum | from their mobile terminals |

TRANSFER_REQUEST or ADD_REQUEST message. (generated by server)

| | |
|---|---|
| IP version | (1) If addressed to a Sorter, a “Distant-host- |
| Message length | address” will be put into the Misc. field. |
| Function - TRANSFER/ADD_REQ | |
| Sorter/New server address (1) | |
| Source, router address(2) | (2) From SERVICE_REQUEST or from |
| router's record no.(2) | previous TRANSFER/ADD_REQUEST |
| User's Internet name(2) | message |
| Available protocols(2) | |
| Misc. - variable length(3) | (3) server - server inf. |
| Checksum. | |

TFR&REF or ADD&REF_REQUEST message (generated by server)

| | |
|---|---|
| IP version | (1) If addressed to a Sorter, a “Distant-host- |
| Message length | address” will be put into the Misc. field. |
| Function - TFR&REF/ADD&REF_REQ. | |
| Sorter/New server address (1) | |
| Source address(2) | (2) From SVCE&REF_REQUEST or from |
| BSC's record no.(2) | previous TFR&REF/ADD&REF₋REQ |
| User's Internet name(2) | message |
| Available protocols(2) | |
| Misc. - variable length(3) | (3) server - server inf |
| Checksum. | |

MOB_TRANSFER REQUEST message (generated by BSC—fixed distant end.)

IP version
Message length.
Function - MOB_TRANSFER_REQ.
New BSC address

| | |
|---|---|
| Distant router address(1) | (1) From SERVICE_REQUEST message, |
| router's record no.(1) | OPEN_ACK message or previous |
| Mobile terminal identity. | MOB_TRANSFER_REQUEST |
| | message |
| Checksum. | |

MOB_TFR&REF REQUEST message (generated by BSC—server or mobile distant end)

| | |
|---|---|
| IP version. | |
| Message length. | |
| Function - MOB_TFR&REF_REQ. | |
| New BSC address | |
| Distant server/BSC address (1) | (1) From SVCE&REF_REQUEST |
| server/BSC record no.(1) | message, OPEN_SVCE&REF |
| Mobile terminal identity. | message or previous |
| Charge-record flag | MOB_TFR&REF_REQ |
| Checksum. | |

OPEN_TRANSFER or OPEN_ADD message (generated by server)

Same as OPEN_SERVICE message apart from name in Function field which indicates TRANSFER or ADD action required.

OPEN_TFR&REF or OPEN_ADD&REF message (generated by server)

Same as OPEN_SVCE&REF message apart from name in Function field which indicates TRANSFER or ADD action required.

OPEN_MOB_TRANSFER message (migrating mobile—fixed distant end)

| | |
|---|---|
| IP version | |
| Message length | |
| Function - OPEN_MOB_TFR | |
| Distant router address(1) | (1) From MOB_TFR_REQUEST |
| Session record no.(1) | message. |
| Checksum | |

OPEN_MOB_TFR&REF message (migrating mobile—server or mobile distant end)

| | |
|---|---|
| IP version | |
| Message length | (1) From |
| Function - OPEN_MOB_TFR&REF | MOB_TFR&REF_REQUEST |
| server/Distant BSC address(1) | message |
| Session record no.(1) | (2) BSCs add their address |
| New BSC address(2) | and session -record no. |
| New BSC record no.(2) | |
| Charge-record flag | |
| Checksum | |

FAILURE Message

IP version

Message length

Function—FAILURE

(As required) [what is as required?]

Checksum

Typical failure messages—(might merely be fault numbers)

Destination address not recognised/protected;

Destination terminal out-of-service/not responding;

Destination terminal location unknown (off-line mobile);

Unable to commit sufficient capacity;

Congestion (unable to commit any capacity)/network failure;

Internet name check fail.

1. A communications protocol for providing a connection-oriented interconnection via an internet protocol communications system between a first mobile terminal and a node, in which the first mobile terminal and the node form part of an internet session; in which the first mobile terminal is initially connected to the node via a first mobile controller (MC) in which the protocol comprises means for providing to the first MC an internet address of the node and a record number identifying the internet session.

2. The communications protocol as a claimed in claim 1 in which the node comprises a fixed terminal, in which the fixed terminal is connected to the internet protocol communications system via a router;
in which the internet address identifies the router, and in which the record number is allocated by the router.

3. The communications protocol as claimed in claim 1 in which the node comprises a server; in which the internet address identifies the server, and in which the record number is allocated by the server.

4. The communications protocol as claimed in claim 1 in which the node comprises a further mobile terminal, in which the further mobile terminal is connected to the internet protocol communications system via a further MC;
in which the internet address identifies the further MC, and in which the record number is allocated by the further MC.

5. The communications protocol as claimed in any above claim including the step of maintaining the session as the interconnection between the first mobile terminal and the node is redirected from via the first MC to via a second MC.

6. The protocol as claimed in claim 5 in which the first MC sends a message via the internet protocol communications system to the second MC for requesting the redirection.

7. The communications protocol as claimed in any one of claims 5 and 6 including the steps of establishing the interconnection as a first virtual message-path (VMP) between the first mobile terminal and the node; and for transferring the interconnection from the first VMP to a second VMP in which the first MC is included in the first VMP and the second MC is included in the second VMP.

8. The protocol as claimed in any one of claims 5 to 7 as dependent from any one of claims 2 to 4 in which the second MC opens the second VMP to the server or to the node's router or to the further MC.

9. The protocol as claimed in claim 8 including the step of extending the second VMP from the node's router to the node via that part of the first VMP that extends between the node's router and the node.

10. The protocol as claimed in claim 8 including the step of extending the second VMP from the further MC to the further mobile terminal via that part of the first VWP that extends between the further MC and the further mobile terminal.

11. The protocol as claimed in any one of claims 5 to 10 in which the second MC instructs the server or the node's router or the further MC to redirect the interconnection from via the first MC to via the second MC.

12. The communications protocol as claimed in any one of claims 5 to 11 in which redirection of the interconnection takes place in a seamless manner.

13. The communications protocol as claimed in any one of claims 5 to 12 including, during redirection of the interconnection, the steps of the node's router accepting messages from the second MC in addition to the first MC for forwarding to the node and at the same time forwarding all messages received from the node for forwarding to the first mobile terminal via the second MC.

14. The communications protocol as claimed in any above claim in which the internet session is initiated by the node; and in which communication between the first mobile terminal and the node takes place over a VMP set up by the first mobile terminal.

15. The communications protocol as claimed in any one of claims 1 to 13 in which the internet session is initiated by the first mobile terminal;
and in which communication between the first mobile terminal and the node takes place over a VMP set up by the first mobile terminal.

16. A communications protocol for interconnecting a first mobile terminal via the internet protocol communications system with another fixed or mobile terminal, in which the first mobile terminal is treated as a special service.

17. A communications system comprising means for implementing the protocol of any above claim.
